(19) United States
(12) Patent Application Publication
(10) Pub. No.: US 2004/0098562 A1
(43) Pub. Date: May 20, 2004

(54) Configurable processor architecture

(76) Inventors: Adrian John Anderson, Chepstow (GB); Michael John Davis, Bath (GB)

Correspondence Address: FLYNN THIEL BOUTELL & TANIS, P.C., 2026 RAMBLING ROAD, KALAMAZOO, MI, 49008-1699, US

(21) Appl. No.: 10/358,985

(22) Filed: Feb. 5, 2003

(30) Foreign Application Priority Data
Nov. 15, 2002 (GB) GB 0226732.6

(51) Int. Cl. G06F 15/00

(52) U.S. Cl. 712/24

(57) ABSTRACT

A processor system includes a programmable very long instruction word (VLIW) processor which is closely coupled to a data memory. There is also provided a memory for storing instruction words for the VLIW processors. A memory access unit is coupled to a data memory and at least one input side is dedicated processor is coupled between a data input and the memory access unit. Furthermore, at least one output side dedicated processor is coupled between the memory access unit and the data output. The input and output side data processors perform operations common to a plurality of data processors on input and output data and the VLIW processor performs operations on data particular to a process being performed by the processor system. The VLIW processor is loaded with different sets of instruction words in dependence on the process being performed by the processor system.

This invention relates to a processor architecture of the type which can be used for a multi-standard broadcast or communications processor.

In a broadcast receiver or communications system it is desirable to support many different transmission standards. For example, a television receiver may operate with a number of different broadcast standards including analogue (NTSC, PAL, SECAM), digital terrestrial (DVB-T, ATSC, ISDB), cable (DVB-C) or satellite (DVB-S, DBS) formats. Also, in two-way radio communications it is desirable to support more than one communication standard. For example, in mobile telephones as new standards have been developed, phones have been produced which operate on more than one of these standards.

Texas Instruments produce a device, the OMAP1510, which combines an ARM925 application processor and a TMS32055x DSP processor to provide multimedia processing in a multi-standard mobile terminal. This device enables the implementation of many low speed data standards, but cannot support high speed data standards such as DVB-T.

Oren Semiconductors produce a device which is compatible with all major digital and analogue television standards in the US : OR51132 Demodulator, October 2002. This device enables the implementation of multi-standard television products for the US market, but cannot support television standards from other parts of the world.

In patent application U.S. 2002/0070796 an architecture is described which aims to be compatible with any digital television broadcast standard around the world. The architecture comprises a plurality of processing units and a standard memory linked to a bus. Different processing units are utilised in dependence on the broadcast standard being received. Some of these are shared between the different standards. The architecture described supported multi-standard television products for worldwide markets, but will not support other data standards such as 802.11a wireless LAN.

Preferred embodiments of the present invention seek to reduce the number of components required in such a processor architecture by arranging for processes common to two or more different standards to be shared between these standards and providing one or more programmable processes to implement functions which are specific to individual standards.

In a preferred embodiment, a modulation and coding processor (MCP) is provided comprising a programmable processor with a closely coupled high-speed memory unit which is accessed by a direct memory access (DMA) unit. The inputs and outputs to the programmable processor are made by the DMA unit via the closely coupled memory unit whilst inputs and outputs received and required by dedicated processors are also coupled to the DMA unit and data required by these is buffered within the high-speed memory unit before a desired output is provided.

The dedicated processors perform functions which are common to many standards and the programmable processors implement functions which are specific to individual standards.

Preferably, the same circuitry is used for modulation and demodulation of broadcast and communication signals for a number of different standards. This allows multi-standard systems to be implemented with a lower component cost that would be the case if a separate demodulation circuit were used for each standard. Also, development time can be reduced for new standards since invariably these will include some functionality which is common to them and existing standards and can therefore be handled by the dedicated processors. Use of such an architecture will also require a smaller amount of memory than known multi-standard processors.

The invention is defined in its various aspects in the appended claims to which reference should now be made.

A preferred embodiment of the invention will now be described in detail by way of example with reference to the accompanying drawings in which:

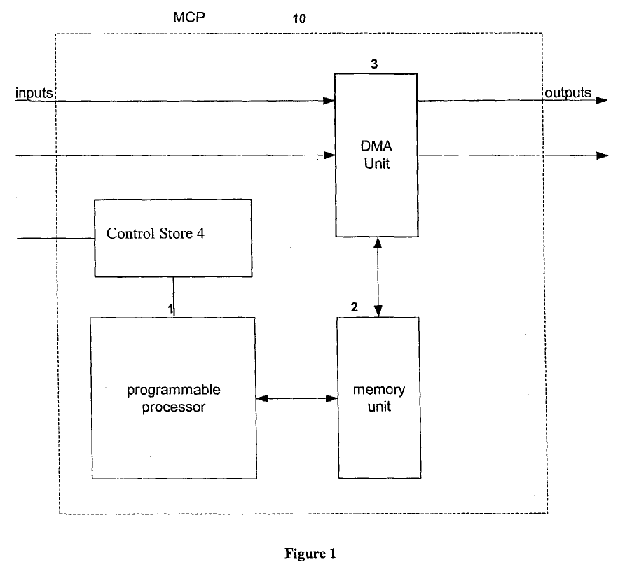

FIG. 1 shows a block diagram of a processing unit for use in an embodiment of the invention; and

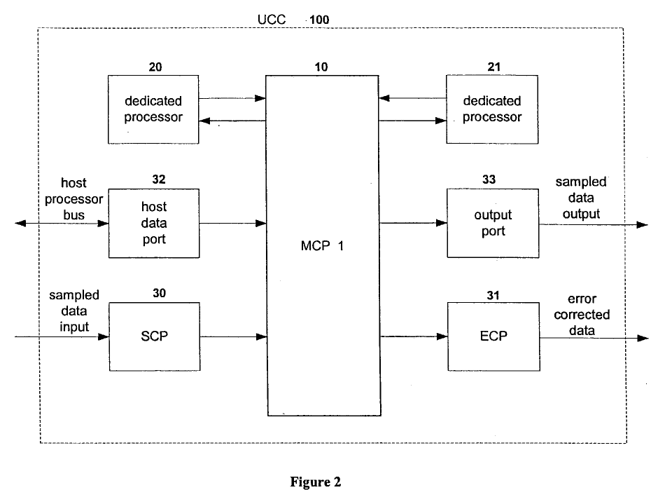

FIG. 2 shows an embodiment of the invention.

In a system-on-chip design incorporating complex signal processing functions, it is frequently the case that memory requires a large proportion of the chip area. To achieve an economical design, it is desirable to make the most efficient use of memory so that the chip area is minimized. FIG. 1 shows a modulation and coding processor 10 (MCP) which is an arrangement of a programmable very long instruction word (VLIW) processor 1 which is close-coupled to a high-speed memory 2. The memory 2 is linked to a DMA controller 3, which in this example has two inputs and two outputs.

The DMA controller 3 enables communication between the MCP 10 and a number of attached processors and peripherals. Each channel of the DMA controller supports continuous transfers by using the close-coupled memory 2 as two buffers in a conventional swing buffer arrangement. If the two buffers are called A and B, completion of buffer A transfers automatically causes buffer B transfers to become active. Similarly, completion of buffer B transfers automatically causes buffer A transfers to become active. In this way each DMA channel may support either a continuous stream of samples such as would be required in a standard like DVB-S, or a continuous sequence of block transfers such as would be required in a standard like DVB-T.

The high speed memory 2 is arranged to provide read or write access to multiple data points in the memory in each clock cycle. The accesses are initiated either by the processor 1 or the DMA unit 3. The programmable VLIW processor 1 supports single instruction multiple data (SIMD) operations to provide a high processing throughput. Thus it can execute the same instruction on a plurality of different items of data simultaneously. When modulating or demodulating a high speed data stream, the same operations have to be performed on a large number of data points. Thus the SIMD operation works very efficiently in performing this task. The programmable VLIW processor 1 has an instruction set which is optimized for processing of complex vectors, supporting arithmetic operations such as FFT, FIR filter, scale, complex rotate, square-root and reciprocal, logical operations such as AND, OR, XOR and XNOR, as well as addressing operations such as indexed addressing, offset addressing and table lookup.

The combination of the multiple-access memory 2 and the SIMD VLIW processor 1 is powerful enough to perform modulation and demodulation processing for a wide range of broadcast data standards such as DVB-T, DVB-S, DVB-C, ATSC and ISDB. It can also support wireless LAN standards such as 802.11a, 802.11b and HiperLAN2. For example, in DVB-T a processor capable of operations on 4 points in parallel is required along with a memory unit capable of holding about 35,000 data points (approximately 100 k bytes). This size of processor will also work with DVB-C, ATSC, 802.11a, HiperLAN2, and ISDB. A smaller processor is acceptable for DVB-S. DVB-T requires the maximum memory of all these standards. DVB-S would require fewer than 1000 data points.

The programmable VLIW processor 1 and the closely-coupled high-speed memory 2 together provide a processing environment that can significantly reduce the amount of memory required to implement a particular standard. This is achieved because, by enabling the rapid processing of a block of data in one unit, the need for multiple working buffers can be avoided.

For example, the DVB-T standard uses coded orthogonal frequency division modulation (COFDM) with a maximum symbol size of 8192 complex points, where each point is represented as a 24-bit value. Therefore, one symbol buffer occupies 24 Kbytes of memory. A known DVB-T demodulator uses a number of different buffers. These are a capture buffer to hold data as it is being collected, an FFT processor with its own symbol buffer, an equalization and demapping processor with another symbol buffer, and yet another buffer for symbol deinterleaving to give a total of four symbol buffers.

This DVB-T demodulation could be implemented as an embodiment of the present invention. This would require the MCP to be able to process four complex data points per clock cycle in order to be fast enough to perform the functions of FFT, equalize, demap and symbol deinterleave in the duration of a COFDM symbol. This allows the DVB-T demodulator to operate with only two symbol buffers operating in a swinging buffer configuration. As data is being processed in one buffer in high-speed memory unit 2 by the processor 1, the next COFDM symbol is being captured to a second buffer in the high-speed memory unit 2 at the same time as previously processed soft decision data is being read out of the same second buffer in the high-speed memory unit 2 by the DMA unit 3. The MCP approach allows the amount of buffer memory in the DVB-T demodulator to be approximately half that used in a conventional system, by using the close-coupled high-speed memory unit 2 as a swing buffer arrangement accessed by the DMA unit 3.

A broadcast or communications receiver generally requires a set of functions that require little or no state memory. These functions can be implemented in one or more dedicated processors that have no direct access to high-speed memory 2, but which can communicate with high-speed memory via DMA channels.

FIG. 2 shows a Universal Communications Coprocessor (UCC) 100. This comprises a demodulation system built around an MCP 10 (as discussed above) and which also contains processors dedicated to functions which are common to most analogue and digital broadcast and communications standards. These dedicated processors provide inputs and outputs to and from the MCP 10. These are discussed below.

A Signal Conditioning Processor (SCP) 30 will be required in any receiver, analogue or digital and is a dedicated processor. It performs the functions of frequency offset correction, sample rate control, filtering and decimation on a signal being processed. The SCP 30 also contains a sample-synchronous timer which may be used to generate interrupts and to control the capture of sampled data to memory. The SCP performs all of the functions generally required for conversion of a sampled-data input signal from an asynchronously sampled real or complex format to a synchronously sampled complex baseband format. The output of the SCP is suitable for demodulation processing by the MCP 10 using either digital or analogue modulation standards.

An Error Correction Processor (ECP) 31 will be required in any digital receiver. It performs the functions of bit de-interleaving, depuncturing, maximum likelihood sequence estimation, convolutional deinterleaving, Reed-Solomon decoding, descrambling of data and cyclic redundancy check (CRC) generation. The ECP 31 performs all of the error correction and detection operations required for digital television, digital radio and wireless LAN standards. The ECP can easily be extended in its operation to address error correction schemes from other standards such as mobile communications.

A host processor port 32 enables communications with a host processor which may coordinate the operations of the UCC 100, or may act as a source or a sink of data. The design of the programmable processor 1 is kept simple by assuming that it will perform only limited processing to coordinate the operation of the UCC with the remainder of the system. By allocating higher-level decision making and interfacing functions to an attached host processor, the system design incorporating the UCC is kept simple and efficient.

The programmable processor has to be loaded with different software in dependence on the standard it is required to decode. The attached host processor 32 arranges for this by writing instructions into a control store 4 in the MCP. The control store is as wide as the instruction word (e.g. 96 bits) and as deep as required for the intended applications (e.g. 640 words). The selection of the standard being decoded will in general be defined differently for each system. It can be a matter for a user to select via software running on the host processor. Alternatively there can be a program which runs on the MCP to identify automatically the standard of a received signal. In either case, the end result is that the host processor will write code into the MCP control store 4 to define the functionality of the UCC overall.

Usually the control store 4 memory can be written to by the host processor when the MCP processor is halted. One instruction per clock cycle can be read from the control store 4 when the MCP is operating. There is no direct connection between the control store 4 and the memory unit 2.

Each instruction word held in the control store 4 is divided into a number of fields which define the operations of the different parts of the MCP. Together they have very broad scope and are defined so as to be sufficient to address the requirements of the various standards being implemented by the system. Each instruction takes one clock cycle and in that clock cycle each of the operations defined in the individual instruction fields is performed.

Dedicated processor blocks 20 and 21 are indicative of functions that may be included in the UCC. For example, dedicated processor 20 may perform FIR filtering, and dedicated processor 21 may perform FFT processing. These dedicated processor blocks may be included in a design if they are needed, or may be omitted if they are not needed. They communicate with data read into memory unit 2 via the DMA unit 3. For example, if the UCC 100 is to be used for COFDM decoding it may be preferable to include an FFT unit.

The use of dedicated processors increases the processing power of the UCC. If the MCP would be overloaded by having to implement certain functions then they are usually best implemented in a dedicated processor, particularly when the functionality of that processor is used by more than one standard.

To demodulate a block structured modulation format such as OFDM, the SCP 30 is programmed to transfer each symbol as it is received into high-speed memory 2 via one of the DMA channels, and to alert the programmable processor 1 when the complete symbol is present in memory 2. The programmable processor 1 responds to the alert by performing the necessary demodulation operations such as FFT (if no dedicated unit exists for this), equalization, demapping and deinterleaving. This is done by executing a sequence of very long instruction words which are fetched from the control store 4, on successive clock cycles. The process is started when the relevant data is present in the memory unit. It can be started either by a signal from the DMA unit 3 or from the host processor. The results are transferred from memory 2 to the ECP 31 via a second DMA channel. The ECP performs error correction and detection functions before transferring the corrected data to another processor. In the case of a digital television receiver the ECP output is a transport stream, and the next processor is a transport stream demultiplexer, which will demultiplex the data to be sent to an MPE video decoder so that a signal suitable for display can be provided.

The processor 1 is programmable and thus when it has to perform a different demodulation operation it will be loaded with different software to enable it to perform the different operation, as discussed above.

The exact arrangement of the UCC 100 will be dependent on the number of different broadcast or communication formats which are to be handled. Thus, a UCC 100 for use in a television receiver would be considerably different to one which is used for two-way radio communication using a number of different formats. It will not usually be necessary to produce a UCC 100 which is capable of handling every known format. Thus, UCC's will be designed in accordance with the purpose to which they are to be put.

It is intended that the UCC as illustrated in FIG. 2 will be provided on a single integrated circuit. This could then form the core of a set-top box for television reception or the core of a plug-in card to a PC capable of receiving television or other communication signals.

The UCC can also be provided as a single integrated circuit or with ports to be coupled to additional dedicated processors as desired.

The MCP architecture can be scaled to give different processing speeds. We have given the example of an MCP for DVB-T which can perform 4 operations in one clock cycle. MCP designs for lower data rates may offer 2 operations per clock cycle or one operation per clock cycle.

For higher throughput, MCP units may be configured in series, using DMA to pass data from one memory to another. Alternatively they may be configured in parallel to perform for example demodulation processing on a COFDM stream where even numbered symbols are processed by one MCP1 and odd-numbered symbols are processed by MCP2, thereby improving the through put of data.

1. A processor system comprising a programmable very long instruction word (VLIW) processor closely coupled to a data memory, a memory for storing instruction words for the VLIW processors, a memory access unit coupled to the data memory, at least one input side dedicated processor coupled between a data input and the memory access unit and at least one output side dedicated processor coupled between the memory access unit and a data output, wherein the input and output side processors perform operations common to a plurality of data processes on input and output data and the VLIW processor performs operations on data particular to a process being performed by the processor system, and wherein the VLIW processor is loaded with different sets of instruction words in dependence on the process being performed by the processor system.

2. A processor system according to claim 1 in which the input side processor comprises a data input processor which receives data and provides it to the memory access unit.

3. A processor system according to claim 1 or 2 in which a host processor provides instruction words to the control store in dependence on the type of data received.

4. A processor system according to claim 3 in which the type of data received is automatically detected.

5. A processor system according to claim 3 in which the type of data is selected in response to a user input.

6. A processor system according to any previous claim in which the processor system is a broadcast receiver processor capable of decoding a number of different data standards.

7. A processor system according to claim 6 in which the broadcast receiver processor is a broadcast television receiver processor.

8. A processor system according to claims 1 to 5 in which the processor system is a radio broadcast receiver processor.

9. A processor system according to claims 1 to 5 in which the processor is a two way communication processor.

10. A processor system according to any previous claim in which the processor system is provided in a single integrated circuit.

11. A processor system according to any previous claim in which the processor system includes additional parts to which further dedicated processors may be coupled.

12. A processor system according to any previous claim in which the close-coupled memory is controlled by the memory access unit to function as a swing buffer.

13. A processor system according to any previous claim including a plurality of programmable processors.

14. A processor system substantially as herein described with reference to the accompanying drawings.
